(19) United States
(12) Patent Application Publication
(10) Pub. No.: US 2013/0324240 A1
(43) Pub. Date: Dec. 5, 2013

(54) SYSTEMS AND METHODS OF ICON OPTIMIZATION IN GAME USER INTERFACE

(71) Applicants: Michael Shim, Seattle, WA (US); Jason Paul Allen, Seattle, WA (US); Derek Gaw, Seattle, WA (US); Jaime Dughi, Seattle, WA (US); Gopi Prashanth, Redmond, WA (US)

(72) Inventors: Michael Shim, Seattle, WA (US); Jason Paul Allen, Seattle, WA (US); Derek Gaw, Seattle, WA (US); Jaime Dughi, Seattle, WA (US); Gopi Prashanth, Redmond, WA (US)

(73) Assignee: Zynga Inc., San Francisco, CA (US)

(21) Appl. No.: 13/782,533

(22) Filed: Mar. 1, 2013

Related U.S. Application Data
(60) Provisional application No. 61/654,543, filed on Jun. 1, 2012.
(60) Provisional application No. 61/658,107, filed on Jun. 11, 2012.

(51) Int. Cl. A63F 13/12

(52) U.S. Cl. CPC A63F 13/12
USPC 463/31

(57) ABSTRACT

A system, machine-readable storage medium storing at least one program, and a computer-implemented method for icon optimization in a game user interface is provided. A request from a client device to access a game user interface of a player may be received, where the game user interface is associated with one or more computer-implemented games hosted by a game networking system. A first manner of displaying one or more icons each representing a computer-implemented game of the one or more computer-implemented games is determined. The first manner of displaying the one or more icons within the game user interface is determined based on one or more game-related factors specific to the player. Display data to display the one or more icons in the first manner may be generated and provided to the client device.

### CROSS-REFERENCE TO RELATED APPLICATIONS

This application claims a priority benefit of U.S. Provisional Application No. 61/654,543, filed Jun. 1, 2012, entitled “Icon Optimization Based on Display Size,” which is incorporated herein by reference in its entirety.

This application also claims a priority benefit of U.S. Provisional Application No. 61/658,107, filed Jun. 11, 2012, entitled “Icon Optimization Based on Player-Related Information,” which is also incorporated herein by reference in its entirety.

### TECHNICAL FIELD

The present disclosure relates to games and applications in general and, in particular, to computer-implemented games. In an example embodiment, one or more icons each associated with a computer-implemented game may be displayed within a game user interface in a manner that is optimized based on game-related characteristics or factors specific to a player, such as the size of the game user interface, player-related information, and the like.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 is a schematic diagram showing an example of a system, according to some embodiments;

FIG. 2 is a schematic diagram showing an example of a social network within a social graph, according to some embodiments;

FIG. 3 is a block diagram showing example components of a game networking system, according to some embodiments;

FIG. 4 is a flowchart showing an example method of optimizing a display of one or more icons based on the display size of a game user interface, according to some embodiments;

FIG. 5 is an interface diagram illustrating an example game user interface having icons displayed in a manner that is optimized for a game user interface of a particular size, according to some embodiments;

FIG. 6 is an interface diagram illustrating an example game user interface having icons displayed in another manner that is optimized for a game user interface of another size, according to some embodiments;

FIG. 7 is a flowchart showing an example method of optimizing a display of one or more icons within a game user interface based on player-related information, according to some embodiments;

FIG. 8 is a flowchart showing an example method of generating game play statistics, according to some embodiments;

FIGS. 9 and 10 are interface diagrams illustrating example game user interfaces having icons displayed in a manner that is optimized based on player-related information, according to some embodiments;

FIG. 11 is a diagrammatic representation of an example data flow between example components of the example system of FIG. 1, according to some embodiments;

FIG. 12 is a schematic diagram showing an example network environment, in which various example embodiments may operate, according to some embodiments; and

FIG. 13 is a block diagram illustrating an example computing system architecture, which may be used to implement one or more of the methodologies described herein, according to some embodiments.

### DESCRIPTION OF EXAMPLE EMBODIMENTS

### Overview

Players of one or more computer-implemented virtual games may be provided with a game user interface associated with one or more games that may each be represented with an icon associated with each game. For example, when the player accesses the game user interface, the icons associated with the one or more games may be presented to the player on the game user interface, and the player may select a game to play by selecting one of the icons. The icons may be displayed on the game user interface in a manner or configuration which is optimized based on any appropriate game-related characteristics or factors related to the player and/or the player's circumstances, such as player-related information (e.g., game play statistics for the player), the display size of the game user interface, and the like.

In some embodiments, players may be provided with the ability to change the size of a game user interface associated with one or more computer-implemented games, and the display of items within the display of the user interface may be optimized accordingly. For example, a user interface associated with one or more games may include one or more icons each associated with the one or more games. A player may click on an icon associated with a game to initiate gameplay for that particular game. When a player resizes the user interface, the display of the icons associated with the games may change accordingly. For example, if the player makes the user interface larger, the number of icons displayed may increase accordingly, or the size and/or contents within each icon can be increased in response to the change in the size of the user interface.

In some embodiments, players of one or more computer-implemented virtual games may be provided with a game user interface having one or more icons each associated with a game, where the one or more icons are displayed in a manner that is optimized based on information related to the player. For example, a game networking system associated with the game user interface may receive from a client device of a player a request to access the game user interface. In response, the game networking system may access player information associated with the player who is requesting access to the game user interface. The game networking system may then determine a manner of displaying one or more icons each associated with a computer-implemented game. The manner of displaying the one or more icons may be determined based on the player information associated with the requesting player as well as any game play statistics associated with any players of the computer-implemented games. For example, the manner of displaying the one or more icons may be based on demographic information associated with the requesting player and any collected statistics associated with that particular demographic. Once the manner of displaying the one or more icons has been determined, the game networking system may generate and provide display data to the client device of the requesting player to display the one or more icons in the determined manner. For example, if the requesting player is male, and statistics show that a particular game happens to be popular with the male demographic, the icon associated with that particular game may be displayed at the beginning of a list of icons for games from which the player may select for game play.

### Example System

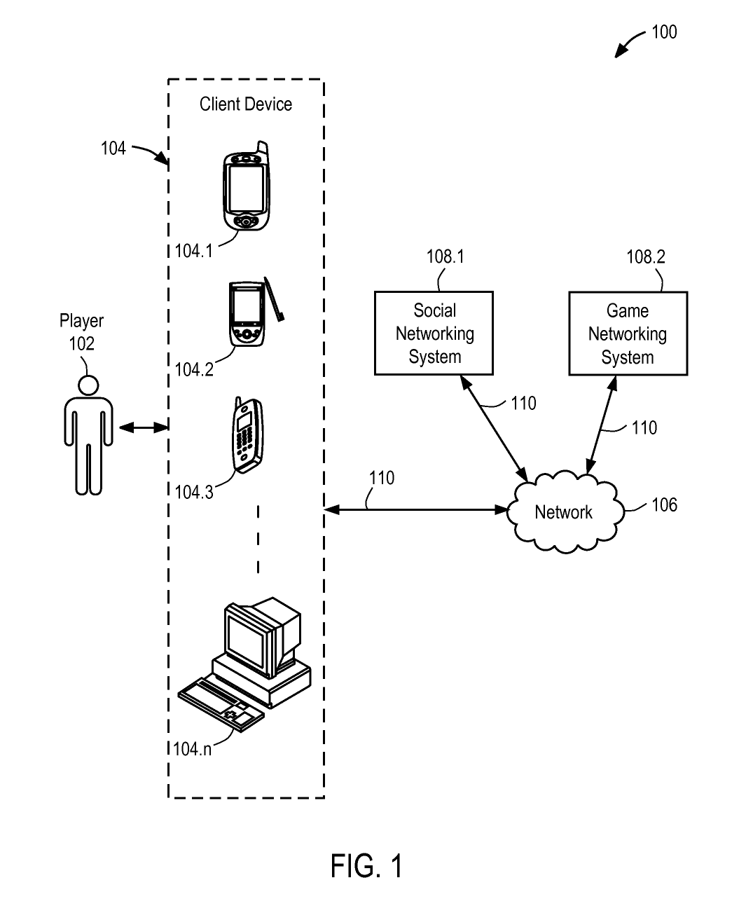

FIG. 1 is a schematic diagram showing an example of a system 100 for implementing various example embodiments. In some embodiments, the system 100 comprises a player 102, a client device 104, a network 106, a social networking system 108.1, and a game networking system 108.2. The components of the system 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The client device 104 may be any suitable computing device (e.g., devices 104.1-104.n), such as a smart phone 104.1, a personal digital assistant (PDA) 104.2, a mobile phone 104.3, a personal computer 104.n, a laptop, a computing tablet, or any other device suitable for playing a virtual game. The client device 104 may access the social networking system 108.1 or the game networking system 108.2 directly, via the network 106, or via a third-party system. For example, the client device 104 may access the game networking system 108.2 via the social networking system 108.1.

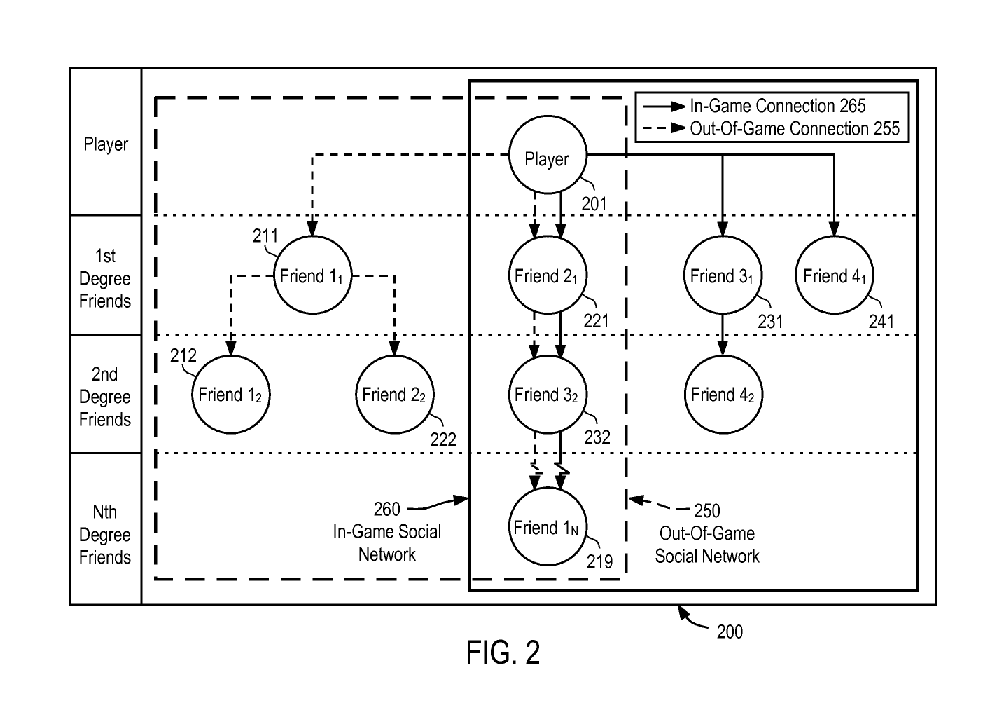

The social networking system 108.1 may include a network-addressable computing system that can host one or more social graphs 200 (see for example FIG. 2), and may be accessed by the other components of system 100 either directly or via the network 106. The social networking system 108.1 may generate, store, receive, and transmit social networking data. Moreover, the game networking system 108.2 may include a network-addressable computing system (or systems) that can host one or more virtual games, for example, online games. The game networking system 108.2 may generate, store, receive, and transmit game-related data, such as, for example, game account data, game input, game state data, and game displays. The game networking system 108.2 may be accessed by the other components of system 100 either directly or via the network 106. The player 102 may use the client device 104 to access, send data to, and receive data from the social networking system 108.1 and/or the game networking system 108.2.

Although FIG. 1 illustrates a particular example of the arrangement of the player 102, the client device 104, the social networking system 108.1, the game networking system 108.2, and the network 106, this disclosure includes any suitable arrangement or configuration of the player 102, the client device 104, the social networking system 108.1, the game networking system 108.2, and the network 106.

FIG. 2 is a schematic diagram showing an example of a social network within a social graph 200. The social graph 200 is shown by way of example to include an out-of-game social network 250, and an in-game social network 260. Moreover, in-game social network 260 may include one or more players that are friends with Player 201 (e.g., Friend 231), and may include one or more other players who are not friends with Player 201. The social graph 200 may correspond to the various players associated with one or more virtual games. In an example embodiment, each player may communicate with other players.

### Example Icon Display Optimization

It is to be appreciated that the virtual gameboard for one or more computer-implemented games may be presented to the player in a variety of manners. In some embodiments, a game user interface associated with one or more computer-implemented games may be provided to a player via a client device of the player. The game user interface may be provided in any manner. In some embodiments, the user interface is provided via a browser window. The user interface may include any game-related features or items, such as a gameboard associated with a game currently being played by the player, one or more icons each associated with and used to access a computer-implemented game, a chat user interface to chat with other players, and the like. The icons associated with games may be presented to the player in a manner that is optimized based on any appropriate or pre-determined game-related characteristics or factors related to the player and/or the player's circumstances, such as player-related information (e.g., game play statistics for the player, in-game friends of the player, out-of-game friends of the player, etc.), the display size of the game user interface, and the like.

In some embodiments, the size of the user interface for the one or more games may be adjusted by the player in any manner. For example, a player may resize the user interface by clicking and dragging the edge of the user interface to a particular size, clicking a button to maximize the size of the user interface, and the like. When a player changes the size of the user interface, the user interface may send a notification to the game networking system 108.2 indicating the change in the size of the user interface. In response, the game networking system 108.2 may determine a manner in which the icons within the user interface should be displayed based on the new size of the user interface. Once the manner of displaying the icons is determined based on the new size of the user interface, the game networking system 108.2 may generate display data to display the icons in the determined manner and send the display data to the user interface on the client device of the player so that the icons may be displayed in the determined manner. The display of the icons may be optimized each time the user interface is resized, as the user interface is being resized, and the like.

The determination of the manner of displaying the icons may be made based on any optimization criteria. For example, the determination may be made based on optimizing the number of icons that may be displayed within a particular display area of the user interface in the new size. In another example, the determination may include determining whether icons of a different size may be displayed within a particular display area of the user interface in the new size. For example, the change in the size of the user interface may allow larger icons having additional content to be displayed within the user interface in the new size.

In some embodiments, the icons may be displayed in a manner which is optimized based on information related to the player associated with the game user interface. For example, if the player is male, icons for games that the male demographic typically plays may be displayed such that icons for those games may be more prominently displayed to the player. The manner of displaying icons within the game user interface may be determined based on any player-related information or data (e.g., demographics, historic effectiveness of aesthetics of a particular icon or the order of icons relative to one another, the games recently played by the player, etc.). A game networking system associated with the game user interface may collect any data relating to game play for players playing the games associated with the game user interface. The game networking system may use any player-related data or any combination of player-related data to analyze which games are more relevant to players. In some embodiments, the data may be based on monitoring the behavior of a subset of players grouped based on any criteria (e.g., age, gender, race, skill level, etc.). In some embodiments, the game networking system may also monitor player activity based on how the icons are aesthetically displayed to players (e.g., icon design, size, placement, etc.). The game networking system may continually collect and analyze the data received from players associated with the game networking system and generate statistics associated with players and their corresponding behaviors, game preferences, and the like. These statistics may be used to provide a player with a game user interface having icons displayed in a manner that is relevant to that particular player based on the characteristics of that player and the statistics associated with other players having the same or at least similar characteristics.

In some embodiments, when a game user interface is provided to a particular player, where the icons are displayed in a manner that is relevant to that particular player, the game networking system may monitor that player's behavior to determine the effectiveness of the manner in which the icons were displayed to the player. If the game networking system determines that the icons could be displayed in a manner which is more effective to the player, the game networking system may store this information and adjust the manner of displaying the icons accordingly. For example, if a player does not click on a particular icon displayed prominently to that player based on statistics associated with characteristics of that player and instead clicks on an icon for a game that was not prominently displayed to the player, the game networking system may note this player activity and may adjust the display of the icons accordingly so that the icons for games that the player may likely play may be displayed more prominently to the player.

In some embodiments, the game networking system may take into account the generated statistics associated with player behavior or preferences, as well as any marketing considerations, when determining the manner of displaying icons. For example, if a new game is being launched or featured by the game networking system, the game networking system may display the icon for the new game prominently and may also display icons for other games based on the particular player associated with that game user interface.

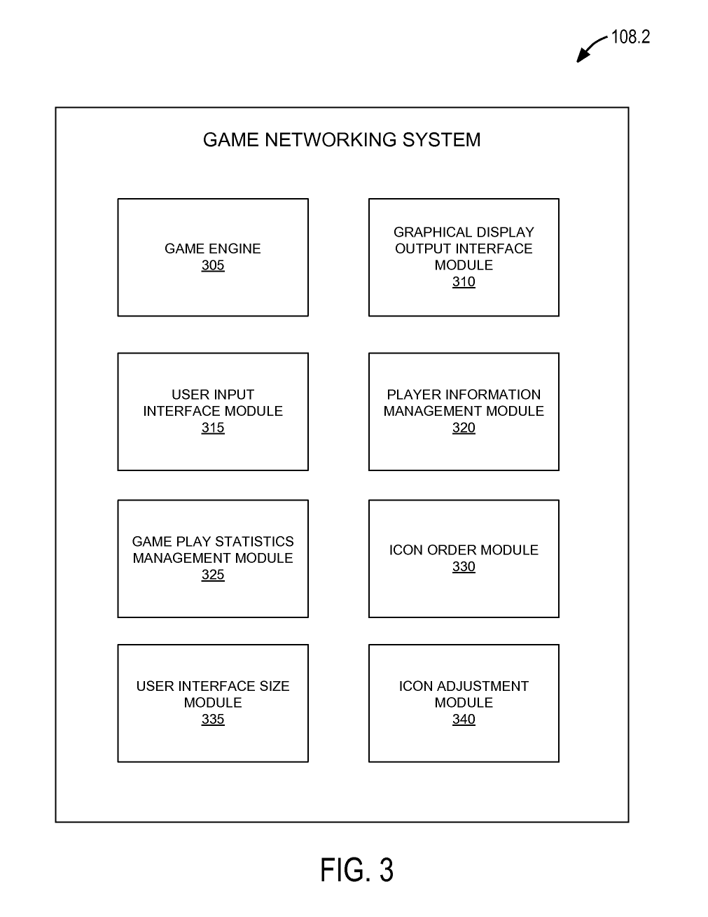

FIG. 3 is a block diagram showing example components of a game networking system 108.2. Game networking system 108.2 may include a game engine 305, a graphical display output interface module 310, a user input interface module 315, a player information management module 320, a game play statistics management module 325, an icon order module 330, a user interface size module 335, and an icon adjustment module 340.

The game engine 305 may be a hardware-implemented module that may manage and control any aspects of a game based on rules of the game, including how a game is played, players' actions and responses to players' actions, and the like. The game engine 305 may be configured to generate a game instance of a game of a player and may determine the progression of a game based on user inputs and rules of the game.

The graphical user display output interface module 310 may be a hardware-implemented module that may manage and control information or data that is provided to client systems for display on a client device. For example, the graphical user display output module 310 may be configured to provide display data associated with displaying a game instance of a game, displaying a user interface associated with one or more games, displaying icons associated with one or more games, and the like.

The user input interface module 315 may be a hardware-implemented module that may receive user inputs for processing by the game engine 305 based on rules of the game. For example, the user input interface module 315 may receive user inputs indicating functions, such as a move made by a player, a request to access a particular game using an icon associated with the game, and the like.

The player information management module 320 may be a hardware-implemented module that may collect information associated with characteristics of players. For example, the player information management module 320 may collect information relating to a player's age, race, gender, skill level, preferences, and the like. When a player requests access to the player's game user interface, the game networking system 108.2 may access player information collected by the player information management module 320 so that the game networking system 108.2 may be aware of characteristics associated with the player requesting access to the game user interface.

The game play statistics management module 325 may be a hardware-implemented module which may monitor player activity for any number of players playing games associated with the game networking system 108.2 and may generate game play statistics associated with game play based on the player activity. The player activity monitored by the game play statistics management module 325 may include any activity, such as player preferences for particular games, player activity related to the aesthetics of an icon for a game, the effectiveness of the location of a particular icon, and the like.

The icon order module 330 may be a hardware-implemented module that may determine the manner and/or order of displaying icons within a game user interface of a player. The icon order module 330 may use the game play statistics generated by the game play statistics management module 325 and the player information associated with the player requesting access to the game user interface to determine the manner of displaying the icons within the game user interface of the player. For example, the icon order module 330 may determine that the player information from the player information management module 320 indicates that the player is male and the game play statistics from the game play statistics management module 325 may indicate that male players have a tendency to play a particular game. As such, the icon order module 330 may determine that the icon for that particular game should be displayed prominently to the player within the game user interface.

The user interface size module 335 may be a hardware-implemented module that may receive and process any notifications from the user interface indicating a change in the size of the user interface to determine the new size of the user interface. For example, the user interface size module 335 may receive, from the game user interface, size information indicating the new size of the game user interface window displaying the game and may process the size information received to determine the new size of the game user interface window.

The icon adjustment module 340 may be a hardware-implemented module that may determine and identify the manner of displaying icons associated with games based on the new size of the user interface. The icon adjustment module 340 may use the size information received from the user interface to determine whether the display of icons should be adjusted, and if so, the manner in which the icons should be displayed. The determination of the manner of display may be made based on any optimization criteria. For example, the icons may be displayed such that the number of icons displayed on the user interface is maximized based on the new size of the user interface, or the type, size, or content of the icons may be displayed such that the display of the icons is optimized based on the available display area on the user interface in the new size.

In some embodiments, the functions performed by the icon order module 330, the user interface size module 335, and the icon adjustment module 340 may be performed by a general icon management module that may manage and control any aspects of, or manners in which, the icons are displayed within the game user interface.

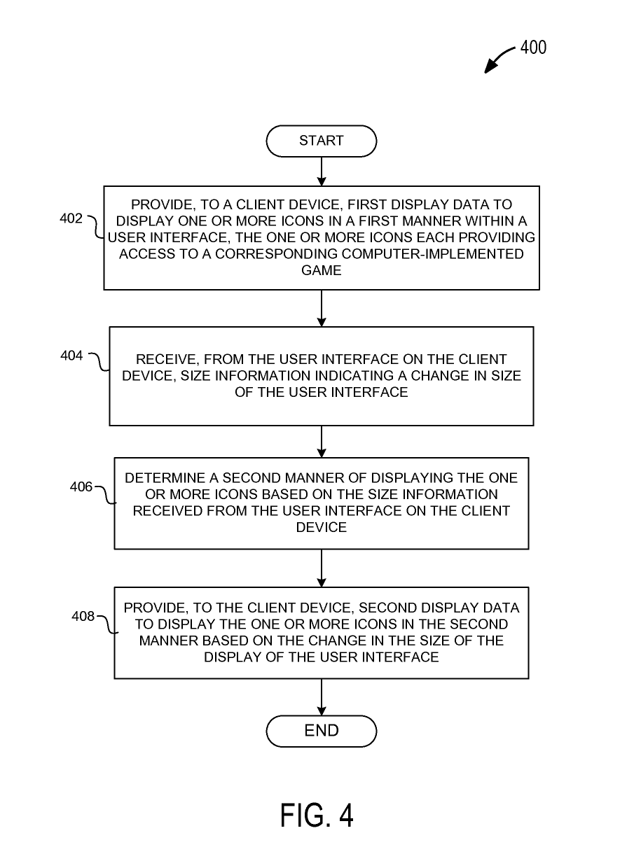

FIG. 4 is a flowchart showing an example method 400 of optimizing a display of one or more icons based on the display size of a game user interface (e.g., a browser). In operation 402, the graphical user display output interface module 310 may generate and provide, to a client device, first display data to display one or more icons in a first manner within a user interface. The one or more icons may each provide access to a corresponding computer-implemented game. The first manner of displaying the one or more icons may be associated with the size of the user interface while the one or more icons are displayed in the first manner.

In operation 404, the user interface size module 335 may receive, from the user interface on the client device, size information indicating a change in size of the user interface. The size information may be received in response to a player changing the size of the user interface. The size information may indicate the change in size as well as the size itself.

In operation 406, the icon adjustment module 340 may determine a second manner of displaying the one or more icons based on the size information received from the user interface on the client device. As previously described, the determination may be made based on any optimization criteria (e.g., maximize the number of icons displayed, maximize the size of the icons displayed, etc.).

In some embodiments, if the size of the user interface has increased due to a change made by the player, the icon adjustment module 340 may determine whether an additional icon associated with an additional computer-implemented game may be displayed with the icons already being displayed. If so, the additional icon may be displayed with the icons already being displayed.

In some embodiments, if the size of the user interface has decreased due to a change made by the player, the icon adjustment module 340 may determine whether any icons within the currently displayed icons should be removed from being displayed within the user interface of the new size. If so, one or more icons may be removed from being displayed. Determining which icons to remove may be performed in any manner based on any criteria.

In some embodiments, the icon adjustment module 340 may determine whether the size of the user interface has reached a particular threshold size (e.g., width of the user interface is greater than or equal to 1200 pixels). If the icon adjustment module 340 determines that the user interface has reached the threshold size, the icon adjustment module 340 may change the icons already being displayed to corresponding icons that are larger (e.g., icons having additional content, etc.). Similarly, if the size of the user interface has decreased below the threshold size, the icon adjustment module 340 may change the larger icons already being displayed to corresponding icons that are smaller (e.g., icons having less content, etc.).

In operation 408, the graphical user display output interface module 310 may generate and provide, to the client device, second display data to display the one or more icons in the second manner based on the change in the size of the display of the user interface. For example, additional or fewer icons may be displayed or corresponding icons having a different size may be displayed based on the new size of the user interface.

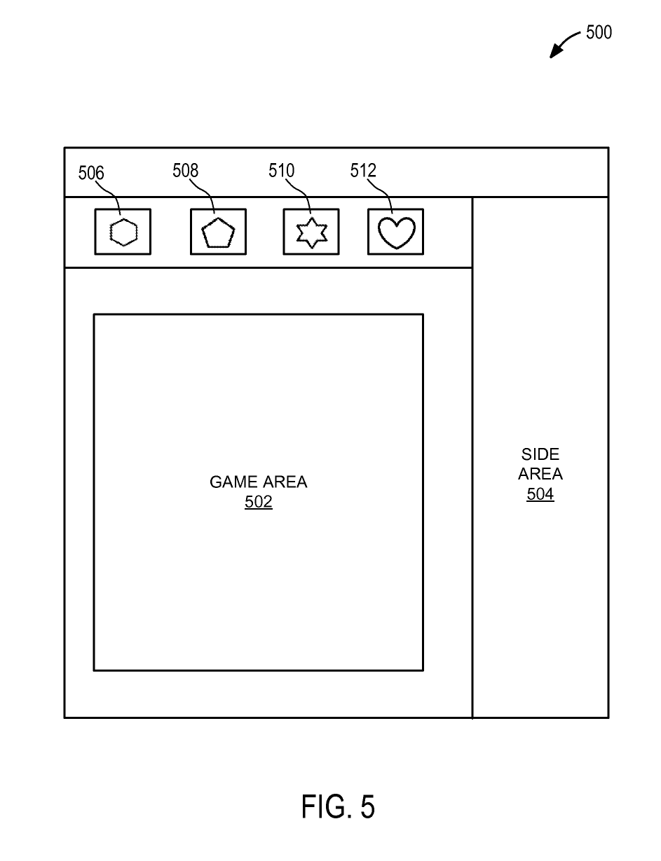

FIG. 5 is an interface diagram illustrating an example game user interface 500 having icons 506, 508, 510, and 512 displayed in a manner that is optimized for a user interface of a particular size. The game user interface 500 may include a game area 502 in which the game may be played (e.g., a gameboard associated with a particular game) and a side area 504 in which any other game features may be displayed (e.g., a chat user interface, a feed displaying other players' activity, etc.). The game user interface 500 may also include icons 506, 508, 510, and 512. Each of these icons may be associated with a particular computer-implemented game. For example, icon 506 may be associated with Game A, icon 508 may be associated with Game B, icon 510 may be associated with Game C, and icon 512 may be associated with Game D. The icons 506, 508, 510, and 512 may depict contents such as a symbol, thumbnail picture, or logo associated with the corresponding game.

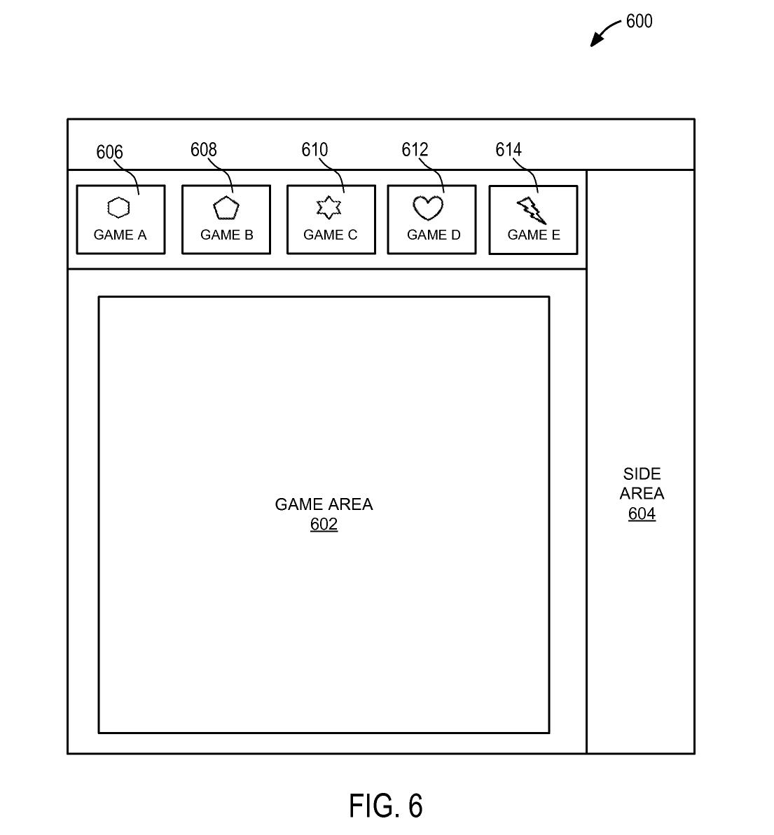

FIG. 6 is an interface diagram illustrating an example game user interface 600 having icons 606, 608, 610, 612, and 614 displayed in another manner that is optimized for a user interface of another size. The example game user interface 600 may be similar to the game user interface 500 of FIG. 5 but may be larger in size than the game user interface 500. For example, a player viewing user interface 500 may click and drag an edge or corner of the user interface 500 to resize the user interface 500 to the size of the user interface 600. In response to the resizing, the manner of displaying the icons may be changed accordingly based on any optimization criteria.

Similar to the user interface 500 of FIG. 5, the user interface 600 may also display a game area 602 and a side area 604. However, the user interface 600 may also display larger icons and additional icons compared to the set of icons displayed in the smaller user interface 500. For example, icons 606, 608, 610, and 612 may correspond to the icons displayed in the smaller user interface 500 but may be larger icons contain additional content (e.g., additional text for the title of the associated game). Icon 614 associated with Game E may be an additional icon added in response to the new size of the game area 602 and/or the side area 604 of the user interface 600.

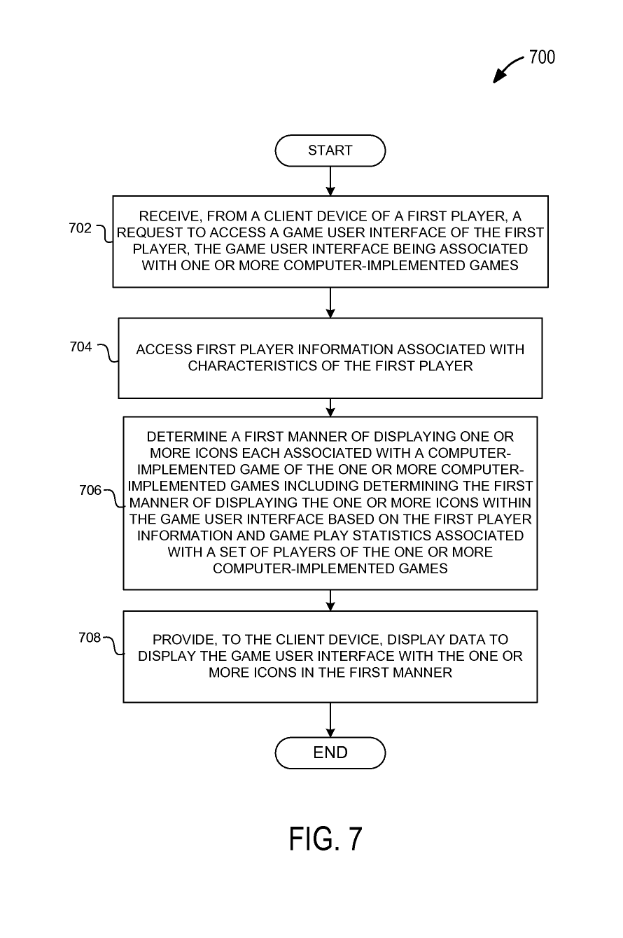

FIG. 7 is a flowchart showing an example method 700 of optimizing a display of one or more icons within a game user interface based on player-related information. The method may be performed using the game networking system 108.2, as shown in FIG. 3.

In operation 702, the user input interface module 315 may receive, from a client device of a first player, a request to access a game user interface of the first player. The game user interface may be associated with one or more computer-implemented games. In some embodiments, the request may be received when the player logs in to the player's account associated with the game networking system 108.2.

In operation 704, the player information management module 320 may access first player information associated with characteristics of the first player. As previously described, this may include any player information managed by the player information management module 320, such as the player's gender, age, race, skill level, and the like.

In operation 706, the icon order module 330 may determine a first manner of displaying one or more icons each associated with a computer-implemented game of the one or more computer-implemented games. This may include determining the first manner of displaying the one or more icons within the game user interface based on the first player information and game play statistics associated with a set of players of the one or more computer-implemented games.

In operation 708, the graphical user display output interface module 310 may provide, to the client device of the first player, display data to display the game user interface with the one or more icons in the first manner. The one or more icons may be displayed to the player in a manner that is relevant to the player's characteristics with respect to the game play statistics generated for players associated with the game networking system 108.2.

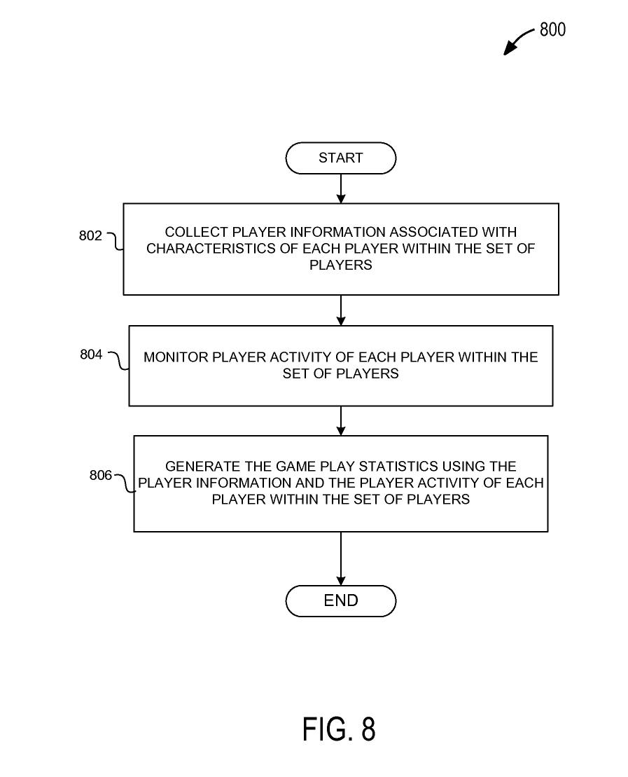

FIG. 8 is a flowchart showing an example method 800 of generating game play statistics. The method may be performed using the game networking system 108.2, as shown in FIG. 3.

In operation 802, the game play statistics management module 325 may collect player information associated with characteristics of each player within the set of players. As previously described, the player information may include any information related to characteristics of the player, such as age, gender, skill level, race, preferences of each player, and the like.

In operation 804, the game play statistics management module 325 may monitor player activity of each player within the set of players. This may include monitoring player activity with respect to the player information collected for each player. For example, the game play statistics management module 325 may monitor the effectiveness of particular features within the game user interface (e.g., icons and their aesthetic features), whether or not a particular player clicked on a particular icon, and the like.

In operation 806, the game play statistics management module 325 may generate the game play statistics using the player information and the player activity of each player within the set of players. For example, the game play statistics may indicate that a particular demographic is likely to play a particular game, that placing an icon in a particular location within the game user interface is more effective (e.g., results in more requests to access the game associated with that icon) than placing the icon in another location, that a particular game is popular among other players from the player's social network and/or outside of the player's social network.

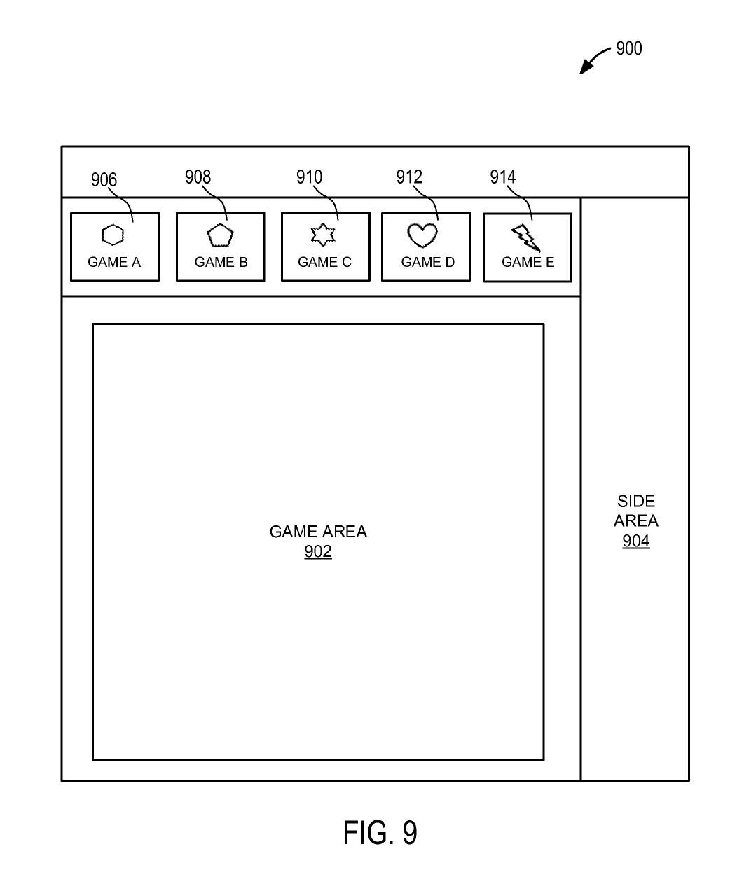

FIGS. 9 and 10 are interface diagrams illustrating example game user interfaces 900 and 1000 having icons displayed in a manner that is optimized based on player-related information. FIG. 9 illustrates a game user interface 900 having a game area 902 in which a game may be played (e.g., a gameboard associated with a particular game) and a side area 904 in which any other game features may be displayed (e.g., a chat user interface, a feed displaying other players' activities, etc.). The game user interface 900 may also include icons 906, 908, 910, 912, and 914, each of which is associated with a particular computer-implemented game. For example, icon 906 may be associated with Game A, icon 908 may be associated with Game B, icon 910 may be associated with Game C, icon 912 may be associated with Game D, and icon 914 may be associated with Game E. These icons may be displayed in a manner that is optimized for the player associated with the game user interface 900. For example, the icons 906, 908, 910, 912, and 914 may be displayed upon the player accessing the game user interface 900 if the icon order module 330 determines that the games associated with the icons 906, 908, 910, 912, and 914 are games that the player would likely play. In a further example, the icon 906 may be displayed at the beginning of the line of icons if the icon order module 330 determines that the player would most likely play the game associated with icon 906. In some embodiments, one of the icons 906, 908, 910, 912, and 914 may include an icon associated with a new or featured game, even if that game is unrelated to any player characteristics.

FIG. 10 illustrates a game user interface 1000 which is similar to the game user interface 900 shown in FIG. 9. The game user interface 1000 may include a game area 1002 in which a game may be played (e.g., a gameboard associated with a particular game) and a side area 1004 in which any other game features may be displayed (e.g., a chat user interface, a feed displaying other players' activities, etc.). Similar to the game user interface 900, game user interface 1000 may also include icons 1006, 1008, 1010, 1012, and 1014, each of which is associated with a particular computer-implemented game. In the example shown in FIG. 10, the icons 1006, 1008, 1010, 1012, and 1014 may be displayed in a different order that the icons were displayed in FIG. 9. This may occur if the icon order module 330 determines that the manner of displaying the icons should be further adjusted for this particular player based on the player's activities, such as which games were played, how long those games were played, how often the games were played, and the like. For example, if the icon order module 330 determines that the player has acted differently than predicted, the icon order module 330 may monitor the player's activity and adjust the display of the icons accordingly.

### Storing Game-Related Data

A database may store any data relating to game play within a game networking system 108.2. The database may include database tables for storing a player game state that may include information about the player's virtual gameboard, the player's character, or other game-related information. For example, player game state may include virtual objects owned or used by the player, placement positions for virtual structural objects in the player's virtual gameboard, and the like. Player game state may also include in-game obstacles of tasks for the player (e.g., new obstacles, current obstacles, completed obstacles, etc.), the player's character attributes (e.g., character health, character energy, amount of coins, amount of cash or virtual currency, etc.), and the like.

The database may also include database tables for storing a player profile that may include user-provided player information that is gathered from the player, the player's client device, or an affiliate social network. The user-provided player information may include the player's demographic information, the player's location information (e.g., a historical record of the player's location during game play as determined via a GPS-enabled device or the internet protocol (IP) address for the player's client device), the player's localization information (e.g., a list of languages chosen by the player), the types of games played by the player, and the like.

In some example embodiments, the player profile may also include derived player information that may be determined from other information stored in the database. The derived player information may include information that indicates the player's level of engagement with the virtual game, the player's friend preferences, the player's reputation, the player's pattern of game-play, and the like. For example, the game networking system 108.2 may determine the player's friend preferences based on player attributes that the player's first-degree friends have in common, and may store these player attributes as friend preferences in the player profile. Furthermore, the game networking system 108.2 may determine reputation-related information for the player based on user-generated content (UGC) from the player or the player's N^{th} degree friends (e.g., in-game messages or social network messages), and may store this reputation-related information in the player profile. The derived player information may also include information that indicates the player's character temperament during game play, anthropological measures for the player (e.g., tendency to like violent games), and the like.

In some example embodiments, the player's level of engagement may be indicated from the player's performance within the virtual game. For example, the player's level of engagement may be determined based on one or more of the following: a play frequency for the virtual game or for a collection of virtual games; an interaction frequency with other players of the virtual game; a response time for responding to in-game actions from other players of the virtual game; and the like.

In some example embodiments, the player's level of engagement may include a likelihood value indicating a likelihood that the player may perform a desired action. For example, the player's level of engagement may indicate a likelihood that the player may choose a particular environment, or may complete a new challenge within a determinable period of time from when it is first presented to him.

In some example embodiments, the player's level of engagement may include a likelihood that the player may be a leading player of the virtual game (a likelihood to lead). The game networking system 108.2 may determine the player's likelihood to lead value based on information from other players that interact with this player. For example, the game networking system 108.2 may determine the player's likelihood to lead value by measuring the other players' satisfaction in the virtual game, measuring their satisfaction from their interaction with the player, measuring the game-play frequency for the other players in relation to their interaction frequency with the player (e.g., the ability for the player to retain others), and/or the like.

The game networking system 108.2 may also determine the player's likelihood to lead value based on information about the player's interactions with others and the outcome of these interactions. For example, the game networking system 108.2 may determine the player's likelihood to lead value by measuring the player's amount of interaction with other players (e.g., as measured by a number of challenges that the player cooperates with others, and/or an elapsed time duration related thereto), the player's amount of communication with other players, the tone of the communication sent or received by the player, and/or the like. Moreover, the game networking system 108.2 may determine the player's likelihood to lead value based on determining a likelihood for the other players to perform a certain action in response to interacting or communicating with the player and/or the player's virtual environment.

### Example Game Systems, Social Networks, and Social Graphs

In a multiplayer game, players control player characters (PCs), a game engine controls non-player characters (NPCs), and the game engine also manages player character state and tracks states for currently active (e.g., online) players and currently inactive (e.g., offline) players. A player character may have a set of attributes and a set of friends associated with the player character. As used herein, the terms “state” and “attribute” can be used interchangeably to refer to any in-game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a player (or a group of more than one players), the game engine may take into account the state of the player character (or group of PCs) that is playing, but also the state of one or more PCs of offline/inactive players who are connected to the current player (or PC, or group of PCs) through the game social graph but are not necessarily involved in the game at the time.

For example, Player A with six friends on Player A's team (e.g., the friends that are listed as being in the player's mob/gang/set/army/business/crew/etc. depending on the nature of the game) may be playing the virtual game and choose to confront Player B who has 20 friends on Player B's team. In some embodiments, a player may only have first-degree friends on the player's team. In other embodiments, a player may also have second-degree and higher degree friends on the player's team. To resolve the game event, in some embodiments the game engine may total up the weapon strength of the seven members of Player A's team and the weapon strength of the 21 members of Player B's team and decide an outcome of the confrontation based on a random variable applied to a probability distribution that favors the side with the greater total. In some embodiments, all of this may be done without any other current active participants other than Player A (e.g., Player A's friends, Player, B, and Player B's friends could all be offline or inactive). In some embodiments, the friends in a player's team may see a change in their state as part of the outcome of the game event. In some embodiments, the state (assets, condition, level) of friends beyond the first degree are taken into account.

Example Game Networking Systems

A virtual game may be hosted by the game networking system 108.2, which can be accessed using any suitable connection 110 with a suitable client device 104. A player may have a game account on the game networking system 108.2, wherein the game account may contain a variety of information associated with the player (e.g., the player's personal information, financial information, purchase history, player character state, game state, etc.). In some embodiments, a player may play multiple games on the game networking system 108.2, which may maintain a single game account for the player with respect to the multiple games, or multiple individual game accounts for each game with respect to the player. In some embodiments, the game networking system 108.2 may assign a unique identifier to a player 102 of a virtual game hosted on the game networking system 108.2. The game networking system 108.2 may determine that the player 102 is accessing the virtual game by reading the user's cookies, which may be appended to HTTP requests transmitted by the client device 104, and/or by the player 102 logging onto the virtual game.

In some embodiments, the player 102 accesses a virtual game and control the game's progress via the client device 104 (e.g., by inputting commands to the game at the client device 104). The client device 104 can display the game interface, receive inputs from the player 102, transmit user inputs or other events to the game engine, and receive instructions from the game engine. The game engine can be executed on any suitable system (such as, for example, the client device 104, the social networking system 108.1, or the game networking system 108.2). For example, the client device 104 may download client components of a virtual game, which are executed locally, while a remote game server, such as the game networking system 108.2, provides backend support for the client components and may be responsible for maintaining application data of the game, processing the inputs from the player 102, updating and/or synchronizing the game state based on the game logic and each input from the player 102, and transmitting instructions to the client device 104. As another example, when the player 102 provides an input to the game through the client device 104 (such as, for example, by typing on the keyboard or clicking the mouse of the client device 104), the client components of the game may transmit the player's input to the game networking system 108.2.

In some embodiments, the player 102 accesses particular game instances of a virtual game. A game instance is a copy of a specific game play area that is created during runtime. In some embodiments, a game instance is a discrete game play area where one or more players 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific players. A game instance is associated with a specific player when one or more game parameters of the game instance are associated with the specific player. For example, a game instance associated with a first player may be named “First Player's Play Area.” This game instance may be populated with the first player's PC and one or more in-game objects associated with the first player.

In some embodiments, a game instance associated with a specific player is only accessible by that specific player. For example, a first player may access a first game instance when playing a virtual game, and this first game instance may be inaccessible to all other players. In other embodiments, a game instance associated with a specific player is accessible by one or more other players, either synchronously or asynchronously with the specific player's game play. For example, a first player may be associated with a first game instance, but the first game instance may be accessed by all first-degree friends in the first player's social network.

In some embodiments, the set of in-game actions available to a specific player is different in a game instance that is associated with this player compared to a game instance that is not associated with this player. The set of in-game actions available to a specific player in a game instance associated with this player may be a subset, superset, or independent of the set of in-game actions available to this player in a game instance that is not associated with him. For example, a first player may be associated with Blackacre Farm in an online farming game, and may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

In some embodiments, a game engine interfaces with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a player or player character in a multiplayer game.

In some embodiments, the social graph is managed by the game networking system 108.2, which is managed by the game operator. In other embodiments, the social graph is part of a social networking system 108.1 managed by a third party (e.g., Facebook, Friendster, Myspace, Yahoo). In yet other embodiments, the player 102 has a social network on both the game networking system 108.2 and the social networking system 108.1, wherein the player 102 can have a social network on the game networking system 108.2 that is a subset, superset, or independent of the player's social network on the social networking system 108.1. In such combined systems, game network system 108.2 can maintain social graph information with edge-type attributes that indicate whether a given friend is an “in-game friend,” an “out-of-game friend,” or both. The various embodiments disclosed herein are operable when the social graph is managed by the social networking system 108.1, the game networking system 108.2, or both.

### Example Systems and Methods

Returning to FIG. 2, the Player 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to Player 201. As used herein, the terms “player” and “user” can be used interchangeably and can refer to any user in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 1₁ 211 and Friend 2₁ 221. In social graph 200, it is possible for individuals to be connected to other individuals through their first-degree friends (e.g., friends of friends). As described above, the number of edges in a minimum path that connects a player to another user is considered the degree of separation. For example, FIG. 2 shows that Player 201 has three second-degree friends to which Player 201 is connected via Player 201's connection to Player 201's first-degree friends. Second-degree Friend 1₂ 212 and Friend 2₂ 222 are connected to Player 201 via Player 201's first-degree Friend 1₁ 211. The limit on the depth of friend connections, or the number of degrees of separation for associations, that Player 201 is allowed is typically dictated by the restrictions and policies implemented by the social networking system 108.1.

In various embodiments, Player 201 can have Nth-degree friends connected to him through a chain of intermediary degree friends as indicated in FIG. 2. For example, Nth-degree Friend 1_{N} 219 is connected to Player 201 within in-game social network 260 via second-degree Friend 3₂ 232 and one or more other higher-degree friends.

In some embodiments, a player (or player character) has a social graph within a multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in Player 201's out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in Player 201's in-game social network 260. In some embodiments, a game engine can access in-game social network 260, out-of-game social network 250, or both.

In some embodiments, the connections in a player's in-game social network is formed both explicitly (e.g., when users “friend” each other) and implicitly (e.g., when the system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (e.g., in disintermediated interactions or the like), but that could be the case.

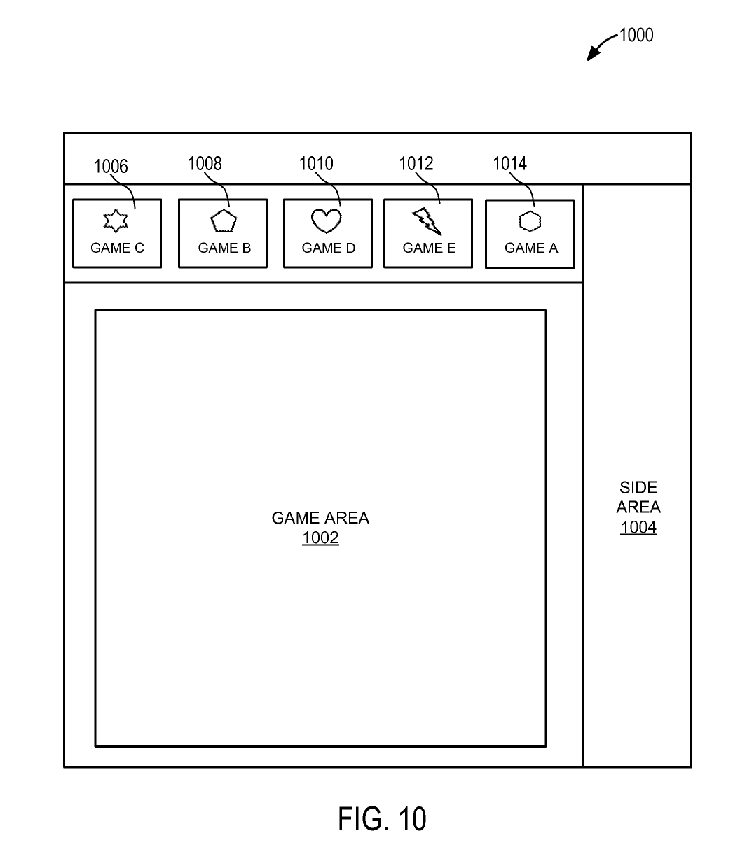

FIG. 11 is a diagrammatic representation of an example data flow between example components of an example system 1100. One or more of the components of the example system 1100 may correspond to one or more of the components of the example system 100. In some embodiments, system 1100 includes a client system 1130, a social networking system 1120a, and a game networking system 1120b. The components of system 1100 can be connected to each other in any suitable configuration, using any suitable type of connection. The components may be connected directly or over any suitable network. The client system 1130, the social networking system 1120a, and the game networking system 1120b may have one or more corresponding data stores such as the local data store 1125, the social data store 1145, and the game data store 1165, respectively.

The client system 1130 may receive and transmit data 1123 to and from the game networking system 1120b. This data can include, for example, a web page, a message, a game input, a game display, a HTTP packet, a data request, transaction information, and other suitable data. At some other time, or at the same time, the game networking system 1120b may communicate data 1143, 1147 (e.g., game state information, game system account information, page info, messages, data requests, updates, etc.) with other networking systems, such as the social networking system 1120a (e.g., FACEBOOK, MYSPACE, etc.). The client system 1130 can also receive and transmit data 1127 to and from the social networking system 1120a. This data can include, for example, web pages, messages, social graph information, social network displays, HTTP packets, data requests, transaction information, updates, and other suitable data.

Communication between the client system 1130, the social networking system 1120a, and the game networking system 1120b can occur over any appropriate electronic communication medium or network using any suitable communications protocols. For example, the client system 1130, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a player accesses a virtual game on the game networking system 1120b, the BLOB containing the game state for the instance corresponding to the player may be transmitted to the client system 1130 for use by a client-side executed object to process. In some embodiments, the client-side executable is a FLASH™-based game, which can de-serialize the game state data in the BLOB. As a player plays the game, the game logic implemented at the client system 1130 maintains and modifies the various game state parameters locally. The client-side game logic may also batch game events, such as mouse clicks, and transmit these events to the game networking system 1120b. Game networking system 1120b may itself operate by retrieving a copy of the BLOB from a database or an intermediate memory cache (memcache) layer. The game networking system 1120b can also de-serialize the BLOB to resolve the game state parameters and execute its own game logic based on the events in the batch file of events transmitted by the client to synchronize the game state on the server side. The game networking system 1120b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a player selects one or more actions to perform. The web pages may be displayed in a browser client executed on the client system 1130. For example, a client application downloaded to the client system 1130 may operate to serve a set of web pages to a player. As another example, a virtual game may be an animated or rendered game executable as a stand-alone application or within the context of a webpage or other structured document. In some embodiments, the virtual game is implemented using ADOBE™ FLASH™-based technologies. As an example, a game may be fully or partially implemented as a SWF object that is embedded in a web page and executable by a FLASH™ media player plug-in. In some embodiments, one or more described web pages is associated with or accessed by the social networking system 1120a. This disclosure contemplates using any suitable application for the retrieval and rendering of structured documents hosted by any suitable network-addressable resource or website.

Application event data of a game is any data relevant to the game (e.g., player inputs). In some embodiments, each application datum may have a name and a value, and the value of the application datum may change (e.g., be updated) at any time. When an update to an application datum occurs at the client system 1130, either caused by an action of a game player or by the game logic itself, the client system 1130 may need to inform the game networking system 1120b of the update. For example, if the game is a farming game with a harvest mechanic (such as ZYNGA™ FARMVILLE™), an event can correspond to a player clicking on a parcel of land to harvest a crop. In such an instance, the application event data may identify an event or action (e.g., harvest) and an object in the game to which the event or action applies.

In some embodiments, one or more objects of a game may be represented as any one of an ADOBE™ FLASH™ object, MICROSOFT™ SILVERLIGHT™ object, HTML 5 object, and the like. FLASH™ may manipulate vector and raster graphics, and supports bidirectional streaming of audio and video. “FLASH™” may mean the authoring environment, the player, or the application files. In some embodiments, the client system 1130 may include a FLASH™ client. The FLASH™ client may be configured to receive and run FLASH™ application or game object code from any suitable networking system (such as, for example, the social networking system 1120a or the game networking system 1120b). In some embodiments, the FLASH™ client is run in a browser client executed on the client system 1130. A player can interact with FLASH™ objects using the client system 1130 and the FLASH™ client. The FLASH™ objects can represent a variety of in-game objects. Thus, the player may perform various in-game actions on various in-game objects by making various changes and updates to the associated FLASH™ objects.

In some embodiments, in-game actions are initiated by clicking or similarly interacting with a FLASH™ object that represents a particular in-game object. For example, a player can interact with a FLASH™ object to use, move, rotate, delete, attack, shoot, or harvest an in-game object. This disclosure contemplates performing any suitable in-game action by interacting with any suitable FLASH™ object. In some embodiments, when the player makes a change to a FLASH™ object representing an in-game object, the client-executed game logic may update one or more game state parameters associated with the in-game object. To ensure synchronization between the FLASH™ object shown to the player at the client system 1130, the FLASH™ client may send the events that caused the game state changes to the in-game object to the game networking system 1120b. However, to expedite the processing and hence the speed of the overall gaming experience, the FLASH™ client may collect a batch of some number of events or updates into a batch file. The number of events or updates may be determined by the FLASH™ client dynamically or determined by the game networking system 1120b based on server loads or other factors. For example, client system 1130 may send a batch file to the game networking system 1120b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to player data or metadata, changes to player social connections or contacts, player inputs to the game, and events generated by the game logic. In some embodiments, each application datum has a name and a value. The value of an application datum may change at any time in response to the game play of a player or in response to the game engine (e.g., based on the game logic). In some embodiments, an application data update occurs when the value of a specific application datum is changed.

In some embodiments, when a player plays a virtual game on the client system 1130, the game networking system 1120b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular player and a particular virtual game. In some embodiments, while a player is not playing the virtual game, the corresponding BLOB may be stored in the database. This enables a player to stop playing the game at any time without losing the current state of the game the player is in. When a player resumes playing the game next time, game networking system 1120b may retrieve the corresponding BLOB from the database to determine the most-recent values of the game-related data. In some embodiments, while a player is playing the virtual game, the game networking system 1120b also loads the corresponding BLOB into a memory cache so that the game system may have faster access to the BLOB and the game-related data contained therein.

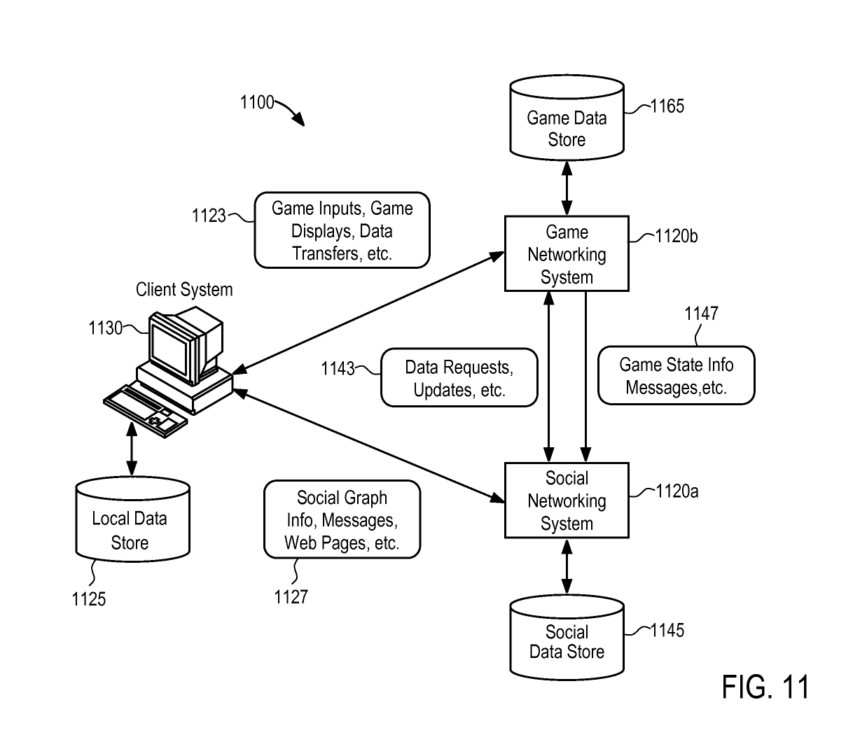

Various embodiments may operate in a wide area network environment, such as the Internet, including multiple network addressable systems. FIG. 12 is a schematic diagram showing an example network environment 1200, in which various example embodiments may operate. Network cloud 1260 generally represents one or more interconnected networks, over which the systems and hosts described herein can communicate. Network cloud 1260 may include packet-based wide area networks (such as the Internet), private networks, wireless networks, satellite networks, cellular networks, paging networks, and the like. As FIG. 12 illustrates, various embodiments may operate in a network environment 1200 comprising one or more networking systems, such as a social networking system 1220a, a game networking system 1220b, and one or more client systems 1230. The components of the social networking system 1220a and the game networking system 1220b operate analogously; as such, hereinafter they may be referred to simply as the networking system 1220. The client systems 1230 are operably connected to the network environment 1200 via a network service provider, a wireless carrier, or any other suitable means.

The networking system 1220 is a network addressable system that, in various example embodiments, comprises one or more physical servers 1222 and data stores 1224. The one or more physical servers 1222 are operably connected to computer network cloud 1260 via, by way of example, a set of routers and/or networking switches 1226. In an example embodiment, the functionality hosted by the one or more physical servers 1222 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), FLASH™, ActionScript, and the like.

The physical servers 1222 may host functionality directed to the operations of the networking system 1220. Hereinafter servers 1222 may be referred to as server 1222, although the server 1222 may include numerous servers hosting, for example, the networking system 1220, as well as other content distribution servers, data stores, and databases. Data store 1224 may store content and data relating to, and enabling, operation of, the networking system 1220 as digital data objects. A data object, in some embodiments, is an item of digital information typically stored or embodied in a data file, database, or record. Content objects may take many forms, including: text (e.g., ASCII, SGML, HTML), images (e.g., JPEG, TIF and GIF), graphics (vector-based or bitmap), audio, video (e.g., MPEG), or other multimedia, and combinations thereof. Content object data may also include executable code objects (e.g., games executable within a browser window or frame), podcasts, and the like.

Logically, data store 1224 corresponds to one or more of a variety of separate and integrated databases, such as relational databases and object-oriented databases, that maintain information as an integrated collection of logically related records or files stored on one or more physical systems. Structurally, data store 1224 may generally include one or more of a large class of data storage and management systems. In some embodiments, data store 1224 may be implemented by any suitable physical system(s) including components, such as one or more database servers, mass storage media, media library systems, storage area networks, data storage clouds, and the like. In one example embodiment, data store 1224 includes one or more servers, databases (e.g., MySQL), and/or data warehouses. Data store 1224 may include data associated with different networking system 1220 users and/or client systems 1230.

The client system 1230 is generally a computer or computing device including functionality for communicating (e.g., remotely) over a computer network. The client system 1230 may be a desktop computer, laptop computer, PDA, in- or out-of-car navigation system, smart phone or other cellular or mobile phone, or mobile gaming device, among other suitable computing devices. Client system 1230 may execute one or more client applications, such as a Web browser.

When a user at a client system 1230 desires to view a particular webpage (hereinafter also referred to as target structured document) hosted by the networking system 1220, the user's web browser, or other document rendering engine or suitable client application, formulates and transmits a request to the networking system 1220. The request generally includes a URL or other document identifier as well as metadata or other information. By way of example, the request may include information identifying the user, a timestamp identifying when the request was transmitted, and/or location information identifying a geographic location of the user's client system 1230 or a logical network location of the user's client system 1230.

Although the example network environment 1200 described above and illustrated in FIG. 12 is described with respect to the social networking system 1220a and the game networking system 1220b, this disclosure encompasses any suitable network environment using any suitable systems. For example, a network environment may include online media systems, online reviewing systems, online search engines, online advertising systems, or any combination of two or more such systems.

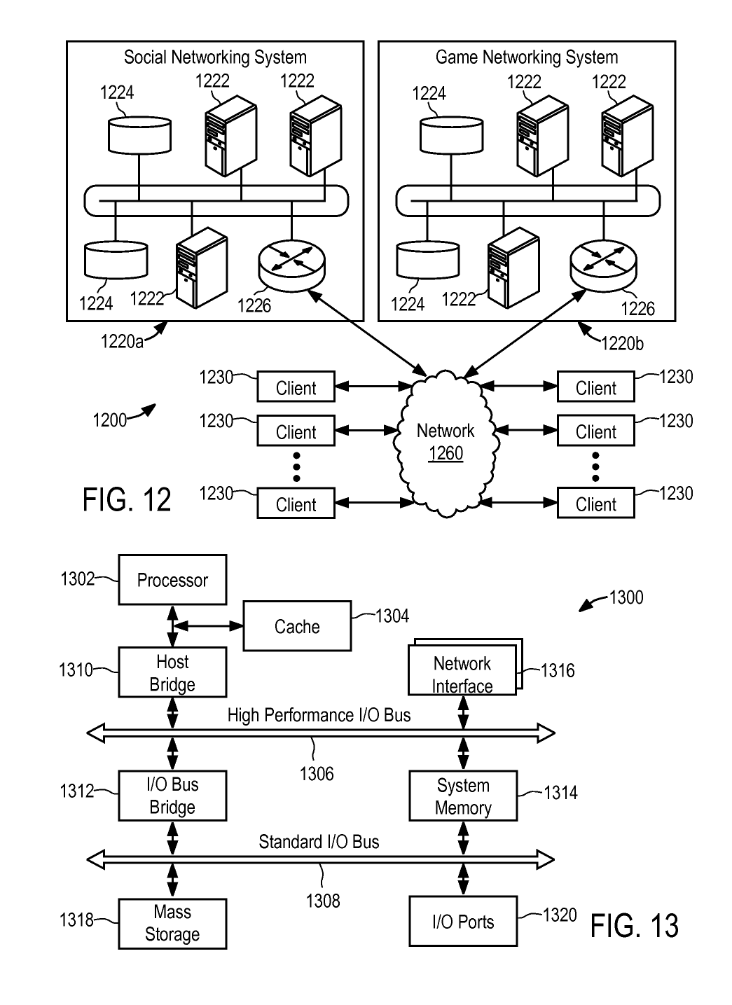

FIG. 13 is a block diagram illustrating an example computing system architecture, which may be used to implement a server 1222 or a client system 1230. In one embodiment, the hardware system 1300 comprises a processor 1302, a cache memory 1304, and one or more executable modules and drivers, stored on a tangible computer-readable storage medium, directed to the functions described herein. Additionally, the hardware system 1300 may include a high performance input/output (I/O) bus 1306 and a standard I/O bus 1308. A host bridge 1310 may couple the processor 1302 to the high performance I/O bus 1306, whereas the I/O bus bridge 1312 couples the two buses 1306 and 1308 to each other. A system memory 1314 and one or more network/communication interfaces 1316 may couple to the bus 1306. The hardware system 1300 may further include video memory (not shown) and a display device coupled to the video memory. Mass storage 1318 and I/O ports 1320 may couple to the bus 1308. The hardware system 1300 may optionally include a keyboard, a pointing device, and a display device (not shown) coupled to the bus 1308. Collectively, these elements are intended to represent a broad category of computer hardware systems.

The elements of the hardware system 1300 are described in greater detail below. In particular, the network interface 1316 provides communication between the hardware system 1300 and any of a wide range of networks, such as an Ethernet (e.g., IEEE 802.3) network, a backplane, and the like. The mass storage 1318 provides permanent storage for the data and programming instructions to perform the above-described functions implemented in servers 1222 of FIG. 12, whereas system memory 1314 (e.g., DRAM) provides temporary storage for the data and programming instructions when executed by the processor 1302. I/O ports 1320 are one or more serial and/or parallel communication ports that provide communication between additional peripheral devices, which may be coupled to the hardware system 1300.

The hardware system 1300 may include a variety of system architectures and various components of the hardware system 1300 may be rearranged. For example, cache memory 1304 may be on-chip with the processor 1302. Alternatively, the cache memory 1304 and the processor 1302 may be packed together as a “processor module,” with processor 1302 being referred to as the “processor core.” Furthermore, certain embodiments of the present disclosure may neither require nor include all of the above components. For example, the peripheral devices shown coupled to the standard I/O bus 1308 may couple to the high performance I/O bus 1306. In addition, in some embodiments, only a single bus may exist, with the components of the hardware system 1300 being coupled to the single bus. Furthermore, the hardware system 1300 may include additional components, such as additional processors, storage devices, or memories.

An operating system manages and controls the operation of the hardware system 1300, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
receiving, at a game server, a request from a client device to access a game user interface of a player, the game user interface being associated with one or more computer-implemented games hosted by the game server;
determining, by the game server, a first manner of displaying one or more icons each representing a computer-implemented game of the one or more computer-implemented games including determining the first manner of displaying the one or more icons within the game user interface based on one or more game-related factors specific to the player;
generating, by the game server, first display data to display the game user interface with the one or more icons in the first manner; and
providing, to the client device, the first display data to display the game user interface with the one or more icons in the first manner.

2. The computer-implemented method of claim 1, further comprising:
accessing player information associated with characteristics of the player, wherein the one or more game-related factors specific to the player includes the player information.

3. The computer-implemented method of claim 2, further comprising:
comparing the player information with game play statistics associated with a set of players of the one or more computer-implemented games to generate the one or more game-related factors specific to the player.

4. The computer-implemented method of claim 3, further comprising:
collecting a plurality of player information associated with characteristics of each player within the set of players;
monitoring player activity of each player within the set of players; and
generating the game play statistics using the plurality of player information and the player activity of each player within the set of players.

5. The computer-implemented method of claim 2, wherein the player information includes demographic information associated with the player.

6. The computer-implemented method of claim 1, wherein determining the first manner of displaying the one or more icons includes determining the first manner based on game play statistics associated with an aesthetic effectiveness of the first manner of displaying the one or more icons.

7. The computer-implemented method of claim 1, further comprising:
monitoring player activity of the player with respect to the one or more icons displayed in the first manner;
determining an adjusted manner of displaying the one or more icons based on the player activity; and
providing, to the client device, adjusted display data to display the game user interface with the one or more icons in the adjusted manner.

8. The computer-implemented method of claim 1, wherein the one or more game-related factors specific to the player includes a size of the game user interface of the player.

9. The computer-implemented method of claim 1, further comprising:
receiving, from the game user interface on the client device, size information indicating a change in size of the game user interface;
determining a second manner of displaying the one or more icons based on the size information; and
providing, to the client device, second display data to display the one or more icons in the second manner based on the change in the size of the game user interface.

10. The computer-implemented method of claim 9, wherein determining the second manner includes determining, based on the size information, whether an additional icon associated with an additional computer-implemented game is capable of being displayed with the one or more icons within the game user interface and wherein providing the second display data includes providing the second display data to display the additional icon with the one or more icons if the additional icon is capable of being displayed with the one or more icons within the game user interface.

11. The computer-implemented method of claim 9, wherein providing the second display data to display the one or more icons in the second manner includes providing the second display data to remove an icon from the one or more icons displayed in the second manner.

12. The computer-implemented method of claim 9, wherein determining the second manner includes determining, based on the size information, whether one or more larger icons corresponding to the one or more icons is capable of being displayed within the game user interface and wherein providing the second display data includes providing the second display data to display the one or more larger icons if the one or more larger icons is capable of being displayed within the game user interface.

13. The computer-implemented method of claim 9, wherein determining the second manner includes determining, based on the size information, whether one or more smaller icons corresponding to the one or more icons is capable of being displayed within the game user interface and wherein providing the second display data includes providing the second display data to display the one or more smaller icons if the one or more smaller icons is capable of being displayed within the game user interface.

14. A machine-readable storage medium storing instructions which, when executed by one or more processors, cause the one or more processors to perform operations, comprising:
receiving a request from a client device to access a game user interface of a player, the game user interface being associated with one or more computer-implemented games;
determining a first manner of displaying one or more icons each representing a computer-implemented game of the one or more computer-implemented games including determining the first manner of displaying the one or more icons within the game user interface based on one or more game-related factors specific to the player;
generating first display data to display the game user interface with the one or more icons in the first manner; and
providing, to the client device, the first display data to display the game user interface with the one or more icons in the first manner.

15. The machine-readable storage medium of claim 14, wherein the instructions cause the one or more processors to perform further operations, comprising:
accessing player information associated with characteristics of the player, wherein the one or more game-related factors specific to the player includes the player information.

16. The machine-readable storage medium of claim 14, wherein the instructions cause the one or more processors to perform further operations, comprising
accessing player information associated with characteristics of the player, wherein the one or more game-related factors specific to the player includes the player information.

17. A game networking system, comprising:
a hardware-implemented user input module configured to receive a request from a client device to access a game user interface of a player, the game user interface being associated with one or more computer-implemented games hosted by the game networking system;
a hardware-implemented icon management module configured to determine a first manner of displaying one or more icons each representing a computer-implemented game of the one or more computer-implemented games including determining the first manner of displaying the one or more icons within the game user interface based on one or more game-related factors specific to the player; and
a hardware-implemented display module configured to:
generate first display data to display the game user interface with the one or more icons in the first manner; and
provide the first display data to display the game user interface with the one or more icons in the first manner.

18. The game networking system of claim 17, further comprising:
a hardware-implemented player information management module configured to manage player information associated with characteristics of the player, wherein the one or more game-related factors specific to the player includes the player information.

19. The game networking system of claim 18, further comprising;
a hardware-implemented game play statistics management module configured to manage game play statistics associated with a set of players of the one or more computer-implemented games, wherein the one or more game-related factors specific to the player includes a comparison of the player information and the game play statistics.

20. The game networking system of claim 17, wherein the one or more game-related factors specific to the player includes a size of the game user interface of the player.
